(19) United States
(12) Patent Application Publication
(10) Pub. No.: US 2013/0167939 A1
(43) Pub. Date: Jul. 4, 2013

(54) Method and System for Reducing the Visibility of a Plume Created at the Outlet of an Industrial Process

(71) Applicant: Brunnschweiler S.A., Munguia (VIZCAYA) (ES)

(72) Inventors: Oscar Lopez, Munguia (ES); Iraide Larrea, Getxo (ES)

(73) Assignee: BRUNNSCHWEILER S.A., Munguia (VIZCAYA) (ES)

(21) Appl. No.: 13/727,239

(22) Filed: Dec. 26, 2012

(30) Foreign Application Priority Data
Dec. 29, 2011 (EP) 11380108

(51) Int. Cl. F17D 1/16

(52) U.S. Cl. CPC F17D 1/16
USPC 137/13; 137/806

(57) ABSTRACT

A method and system for reducing the visibility of a plume created at the outlet of an industrial process, where the industrial process expels hot, humid air into the outside air through an output area of an outlet and, as a result of the expelled air A coming into contact with the outside air E, a visible plume might otherwise be created. The method includes the steps of having an auxiliary air that is dryer than the process air and hotter than the outside air available and combining this auxiliary air with the hot, humid process air such that the auxiliary air forms a protective, insulating or sheathing layer of air around the process air. This combination of the process air with the auxiliary are is carried out after (i.e., downstream from) an extraction process or processes of the industrial process and in the atmosphere generally adjacent to the output area of the process outlet.

### CROSS-REFERENCE TO RELATED APPLICATION

This application claims priority to European Patent Application No. 11380108, filed Dec. 29, 2011. The contents of that application are incorporated by reference in their entirety.

### BACKGROUND OF THE INVENTION

1. Field of the Invention

The invention relates to a method and system for reducing the visibility of a plume created at the outlet of an industrial process, which to date is usually visible at the chimney outlet or other outlet of the industrial process.

2. Description of Related Art

Certain types of industrial facilities, such as paper drying plants, generate large amounts of very hot, humid waste air, i.e. very hot air loaded with a great mass of water vapor. This air, usually called “exhaust” air, is emitted directly into the atmosphere, producing some important negative effects, among which is the effect known as a visible “plume”. The visible plume is a very high column of what looks like white smoke, which is created as follows: when the very hot, humid exhaust air comes into contact with the much colder outside air, sudden condensation of the water vapor contained in the exhaust air takes place; as a result of this condensation, the exhaust air will be filled with a very large number of small water droplets in suspension, which agglomerate on tiny particles of dust and other materials present both in the humid exhaust air of the process and in the environmental air; the water droplets reflect and refract rays of sunlight in all directions and wavelengths, thus causing the plume of exhaust air—which is actually akin to a harmless cloud—to look like white smoke being released into the atmosphere.

Visible plumes are undesirable for several reasons. On the one hand, they are unsightly and they are perceived by the population as a sign of pollution because they look like a column of smoke. On the other hand, if the temperature outside the chimney is very low, the drops of water condensed on leaving the chimney and coming into contact with the outside air can freeze, thus causing the plume to behave like a snow cannon, which might even cause safety problems (poor visibility, accessibility problems, etc.).

Currently, some methods of reducing or eliminating visibility of the exhaust plume are known, including a method based on mixing the humid exhaust air from the industrial process with dry outside air heated to a temperature usually somewhat higher than the temperature of the humid exhaust air. The mixture or dilution achieved in this way has a humidity content midway between the outside air and the humid process air, thereby reducing its relative humidity and distancing it from saturation conditions. The air mixture so obtained is released directly into the atmosphere after passing through a mixing chamber.

In such a process, the moist process air and the dry outside are typically mixed in a mixing chamber which is located in the process air extraction circuit itself. In order to ensure proper mixing of the two types of air, the chamber usually occupies a high volume to ensure proper turbulent mixing of the two types of air prior to it being released into the atmosphere. This chamber is sometimes located in the suction section of the process extraction fan itself, which adds the need for the fan to be excessively oversized. Other times, the chamber is located in the impeller section of the process extraction fan, imposing an important counterpressure on the fan, not originally foreseen, which might cause a decrease in the extraction flow. The decrease in flow sometimes becomes unacceptable for the operation of the extraction equipment and can end up reducing the effectiveness of the process of extracting humid air from the industrial process exhaust to unacceptable limits.

Additionally, mixing hot, humid process air with drier air works best for industrial processes in which the humidity of the exhaust air is relatively low, and there are some important industrial processes that tend to exhaust air with much higher levels of humidity. For example, in paper manufacture processes, which involve removing significant amounts of moisture from pulp, the exhaust air may simply be too humid for the kinds of mixing processes described above to work effectively—with humid air of this type, particularly in cold climates, a plume is almost certain to form. Thus, it would be advantageous to have systems and processes that are able to reduce or eliminate the possibility of a plume with both more humid and less humid exhaust air.

It is an objective of this invention to provide a method and system for reducing visibility of the plume created at the outlet of an industrial process, in which the above-mentioned disadvantage is at least partially overcome. The plume will be rendered partially or even totally non-visible, at least within the immediate vicinity of the outlet of the industrial.

Additionally, it is an objective of the invention to provide a method and system for reducing the visibility of an industrial plume that consume sufficiently low amounts of energy for them to be implemented in industry.

### SUMMARY OF THE INVENTION

The invention provides a method and system for reducing the visibility of a plume created at the outlet of an industrial process, which industrial process expels hot, humid air into the outside air through an outlet and where, as a result of the expelled air coming into contact with the outside air, a visible plume might otherwise be created. A method according to the invention includes the steps of: providing auxiliary air, which is dryer than the industrial process air and hotter than the outside air; and forming an insulating boundary layer around the plume of hot, humid air being exhausted from the industrial process using the auxiliary air to do so. Thus, the industrial process air is sheathed in the auxiliary air, at least in the immediate vicinity of the output area of the outlet.

Sheathing or cloaking the industrial process exhaust air with the auxiliary air outside of the extraction process and independently from it eliminates the need for large-volume mixing apparatus and/or the need to excessively oversize the process extraction fan (in both flow and pressure if located in the fan suction section, and only in pressure if located in the impeller section). Additionally, the inventive method reduces or eliminates adverse effects on the extraction process circuit attributable to the load loss caused by placing a mixing chamber within the extraction process circuit, per se. Suitably, the cloaking or sheathing process is performed relatively quickly after the process exhaust air exits through the process outlet, thereby accelerating the processes of transferring heat, mass, and momentum between the three different types of air (process air, auxiliary air, and outside air) that will be juxtaposed with each other and reducing the influences of outside wind on the various transfer processes.

In one embodiment of the invention, sheathing of the hot, humid process air with the auxiliary air is carried out by providing an external jet of auxiliary air, which encircles the hot, humid process air to form a protective boundary layer of air. The external jet of auxiliary air insulates the hot, humid process air from the outside air when the process air is expelled to the outside through the outlet. The external jet of hot, dry auxiliary air allows the outside air to gradually absorb the hot, humid air from the industrial process without any abrupt, direct contact between the two that might otherwise cause rapid condensation of the moisture in the process air and hence a visible plume.

It should be noted that the outside air is referred to herein as “dry” air because it is usually significantly drier than the process air. Nevertheless, strictly speaking, the outside air will obviously contain a certain amount of humidity.

The auxiliary air can come from various sources. For instance, the auxiliary air might be outside air which has been heated to a suitable temperature. It might also, in another example, be air from inside a machine, already hot and somewhat humid. The auxiliary air might even come from some another process where hot, dry air is produced (e.g., by being heated and dehumidified).

### BRIEF DESCRIPTION OF THE DRAWINGS

The invention will be described with respect to the following drawing FIG.s, in which like numerals represent like features throughout the invention, and in which:

FIG. 1 is a schematic, elevation view of one embodiment of a system according to the invention and in which:

FIG. 2 is a schematic, perspective view of the outlet portion of the system illustrated in FIG. 1; and

FIG. 3 is a schematic illustration showing how the process air and the auxiliary air flow in the system illustrated in FIG. 1.

### DETAILED DESCRIPTION OF THE INVENTION

Embodiments of the invention provide a method and corresponding apparatus for reducing the visibility of a plume created at the outlet of an industrial process, where the industrial process expels hot, humid air A into the outside air E through an outlet 1 and, as a result of the expelled air coming into contact with the outside air, a visible plume might otherwise be created.

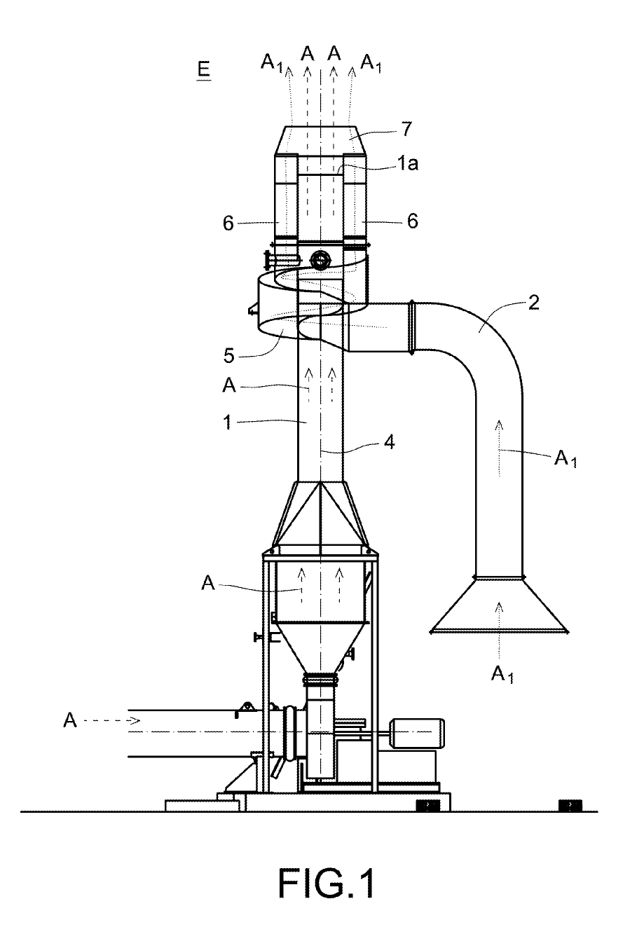

FIG. 1 shows a diagram of a first embodiment of a system according to the invention, which performs the steps of a method according to the invention. This system includes, as a main item, an outlet 1 provided with an output area 1a to allow for the expulsion of the hot, humid air A into the outside atmosphere (which comprises outside air E). The hot, humid air A from the industrial process has been represented using dashed lines. The outlet 1 shown in FIG. 1 is a chimney, although it could also take other forms, for example, any diffuser, a vertical or horizontal air accelerator outlet, or a high speed ejector.

The industrial process itself may be any industrial process that results in the expulsion of hot, humid exhaust air. In some embodiments, the process may be a paper manufacture or paper drying process. Depending on the embodiment, systems and methods according to the invention may be used in conjunction with systems that are used to recover heat and moisture and remove pollution from exhaust streams of air from industrial processes, such that the hot, humid air A is not at its original exhaust temperature and humidity level, but at lower, but still potentially plume-creating, levels of temperature and humidity after heat- and moisture-extracting processes. For example, U.S. patent application Ser. No. 13/720,752, filed on Dec. 19, 2012, the contents of which are incorporated by reference in their entirety, discloses particular systems and methods for removing heat, moisture, and pollution from exhaust streams of air, and some of the embodiments may be used in conjunction with embodiments of the present invention.

A method according to the invention includes the steps of: providing auxiliary air A₁, which in FIG. 1 is represented using dotted arrows travelling or being drawn though a flue 2; combining this auxiliary air A₁ with the hot, humid air A resulting from the industrial process; and expelling the combination of both types of air A, A₁ into the outside air E. (In the context of the invention, “combining” and “combination” do not mean mixing and mixture; rather, the terms refer to bringing together the two types of air, with the auxiliary air surrounding and sheathing the process air as summarized above and as illustrated in the figures.)

The auxiliary air A₁ itself is most advantageously drier than the hot, humid air A and warmer than the ambient or outside air E. For example, in some embodiments, the temperature of the auxiliary air A₁ may be 10-30° C. with a humidity that substantially matches the humidity of the outside air E. The temperature of the auxiliary air A₁ in any particular embodiment or installation will vary depending on the exhaust temperature of the industrial process and the outside or ambient conditions. The more humidity in the exhaust and the colder the outside air E, the hotter the auxiliary air A₁ would typically be.

By contrast, the industrial process exhaust temperature might be in the range of 30-40° C., with humidity in the range of 0.027 to 0.049 kilograms of water per kilogram of dry air in some cases, and up to 100-150° C. in other cases, with humidity in the range of 0.080 to 0.150 kilograms of water per kilogram of dry air. The higher ranges of temperature and humidity conditions of the hot, humid air A would typically be the result of paper formation, pressing, and drying processes. Thus, systems and processes according to embodiments of the invention can be applied to exhaust air A with lower or higher humidity levels.

The manner in which the auxiliary air A₁ is heated to the appropriate temperature is not critical to the invention, and may be done in any number of ways. In some embodiments, the auxiliary air A₁ may be prepared by using waste heat from the industrial process or other industrial processes, e.g., by heat exchange with the stream of hot, humid process air A prior to the systems and methods according to embodiments of the invention. Other forms of waste heat that might be used to heat the auxiliary air A₁ include waste heat from gas turbines used in many industrial processes and waste heat from absorption cooling and/or refrigeration cycles.

In other embodiments, the auxiliary air A₁ may be heated by a primary heat source, such as gas combustion, steam condensation, or thermal oil sensible heat transfer. Of course, in most embodiments, it is more advantageous to use the waste heat from the industrial process itself, or other industrial processes, to heat the auxiliary air A₁.

In these methods and systems, the combination of hot, humid process air A and auxiliary air A₁ is carried out in the atmosphere generally adjacent to the output area 1a of the outlet 1. The atmosphere “generally adjacent to” the output area of the outlet 1 is understood to mean an area not situated inside the outlet (for instance, the inside of the chimney flue), but rather located both in front of and at the sides of this output area 1a and extending perhaps a few meters from the output area 1a. The objective is for the two types of air A, A₁ to be brought together and for the process air A to be sheathed in the auxiliary air A₁ at the beginning of the theoretical mixing length, which is the distance along which the process air A and the outside air E otherwise would mix if the auxiliary air A₁ were not present.

The term “mixing length” should be understood to mean the distance from the output area 1a in which the following phenomena would take place in the absence of the present invention: first, the air A that comes up against the outside air E at rest would push and displace the outside air E and would therefore be decelerated; second, the part of external air E next to but not right in front of the output area 1a, which would initially be at rest, would be induced to move (entrained) because the outer layers of the air A would create friction against the external air E and force it to increase its speed, thereby inducing it to move in the same direction (what is known as shear flows), in exchange for which these outer layers of air A would yield part of their momentum to the external air E.

Introducing the auxiliary air A₁ right where both phenomena occur eliminates or significantly reduces contact between the air A from the industrial process and the outside air E, which contact otherwise could cause rapid condensation of moisture in the process air and hence visibility of the plume. In addition, injecting auxiliary air A₁ at the beginning of the theoretical mixing length between the air A from the industrial process and the outside air E shortens the mixing length as compared to that which would exist in the absence of the invention. With a reduced mixing length, the combined airflow will be less influenced by the air currents in the area, and it will be less difficult to maintain an external jet 3 that is thick enough to prevent the direct mixing of the air A from the industrial process with the outside air E, which, as has been explained above, could otherwise cause a plume to be visible.

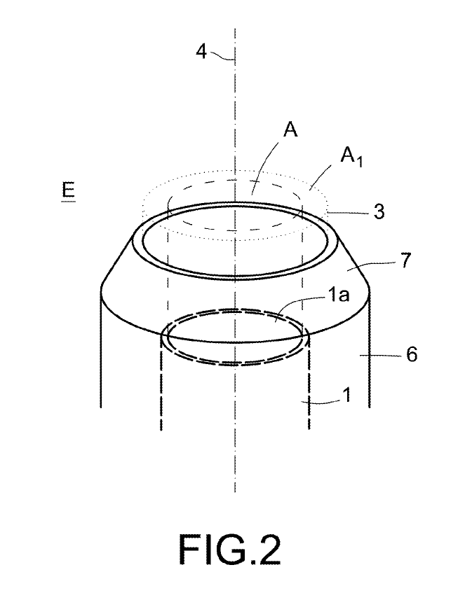

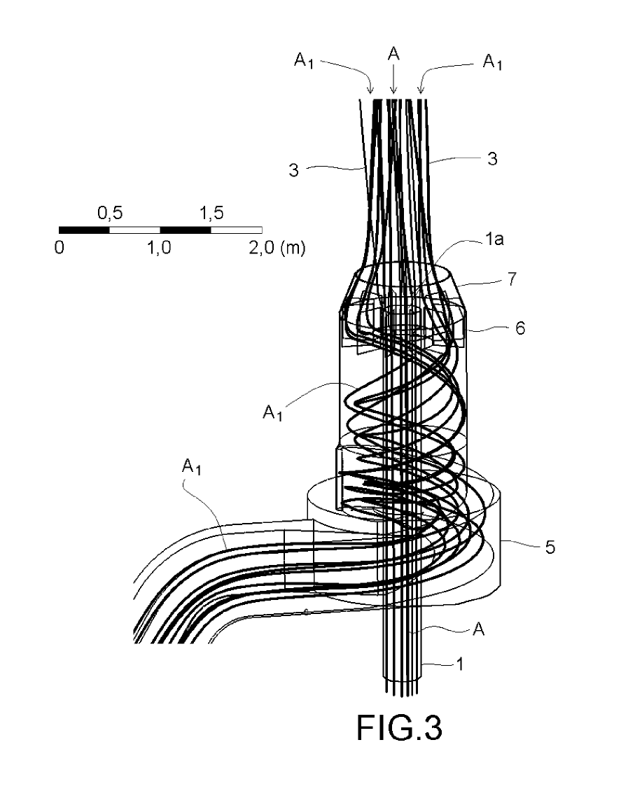

Optionally, the auxiliary air A₁ is combined (i.e., brought into sheathing or surrounding arrangement) with the hot, humid process air A by providing an external jet 3 of auxiliary air A₁ surrounding the air A, as schematically shown in FIGS. 2 and 3. FIG. 2 is especially schematic as in reality the types of air A, A₁ would already begin to mix together as soon as they came into contact with each other (FIG. 3 is more realistic in this regard); nonetheless, FIG. 2 enables better appreciation of how the external jet 3 of auxiliary air A₁ initially surrounds the air A from the industrial process.

According to an embodiment of the invention, the external jet 3 is provided with a speed component in an axial direction 4 towards the exterior of the outlet 1 that is greater than or equal to the speed at which the process air A is expelled from the outlet 1. This helps ensure that the external jet 3 has enough momentum to accompany the air A at any time and protect it from the outside air E.

When the combined flow of the hot, humid process air A from the industrial process and the protective external jet 3 of auxiliary air A₁ is expelled into the outside air E, the external jet 3 of auxiliary air A₁ exchanges heat (i.e. temperature) and momentum with the outside air E, and the auxiliary air A₁ exchanges (i.e., it receives) humidity (i.e. moisture content), heat, and momentum from the hot, humid process air A. As a result, the process air A from the industrial process is progressively cooled and decelerated by the protective external jet 3 of the auxiliary air A₁ as the latter, in turn, is decelerated and cooled by the outside air E, whereas the outside air E in the proximity of this protective external jet 3 of auxiliary air A₁ is, in turn, heated and accelerated. Simultaneously, the humidity content of the protective external jet 3 of auxiliary air A₁ progressively increases by exchange with the hot, humid process air A while, at the same time, its temperature decreases and it is decelerated by the outside air E. Finally, the humidity content of the hot, humid process air A is reduced by exchange with the protective external jet 3 of auxiliary air A₁ and it is decelerated by its exchange of momentum with this external jet 3. All of these exchange processes lead to the gradual absorption of the hot, humid process air A into the outside air E without any abrupt, direct contact between the two A, E that might otherwise cause a visible plume to exist.

In addition, a method according to embodiments of the invention can include the additional step of forcing a relative vacuum in the outlet 1. This helps to compensate for the slight counter-pressure that the friction or exchange of momentum between the protective external jet 3 and the process air A might generate. In this way, this slight relative vacuum makes it possible to gain some static pressure in the process extraction system that will eventually compensate for the slight friction effect described above.

In another aspect, the invention also provides a system for reducing the visibility of a plume created at the outlet from an industrial process, where this industrial process expels hot, humid process air A into the outside air E through an outlet 1 and, as a result of the expelled air A coming into contact with the outside air E, created visible plume might otherwise be created (i.e., in the absence of the invention). An embodiment of a system according to the invention includes a combiner element that brings auxiliary air A₁ into sheathing relationship with the hot, humid air A from the industrial process, which combiner element is located after (i.e., downstream of) an extraction process or processes of the industrial process and in the atmosphere generally adjacent to the outlet 1.

According to the invention, the combiner element delivers an external jet 3 of auxiliary air A₁ surrounding the process air A. The advantages and utilities of expelling the process air A accompanied by an external jet 3 that surrounds it, by way of protection, have been explained earlier.

Suitably, to provide the external jet 3 of auxiliary air A₁ surrounding the process air A, the combiner element comprises a cyclone intake unit 5. An example of such a cyclone intake unit 5 is illustrated in the system shown in FIG. 1. A cyclone intake unit 5 is a unit that directs the auxiliary air A₁ by making it turn in a spiral, like a cyclone, thereby converting the predominantly tangential speed component of the auxiliary air A₁ into a component predominantly in an axial direction 4, and helping to ensure that distribution of the flow or thickness of the layer of protective auxiliary air A₁ is as uniform possible. This spiral movement of the auxiliary air A₁ has been shown schematically in FIG. 3.

Due to the dimensional limitations inherent to every industrial application that might impose smaller dimensions on the cyclone intake unit 5, the external jet 3 of auxiliary air A₁ might still have, in spite of everything, a relatively important tangential speed component, i.e. a component that is perpendicular to the axial direction 4 of the outlet 1. For this reason, the system may also optionally include at least one flow straightener 6 to convert at least part of the speed component perpendicular to the axial direction 4 into a speed component in the axial direction 4 and towards the outside of the outlet 1. This will help ensure that any tangential speed component, or the greater part of it at least, is converted into a component in the axial direction 4.

In addition, the plume visibility reduction system may include a high speed ejection section 7 in the output area of the outlet 1 to force a relative vacuum in the outlet 1. The purpose of such a relative vacuum is explained above.

While the invention has been described with respect to certain embodiments, the description is intended to be exemplary, rather than limiting. Modifications and changes may be made within the scope of the invention, which is set forth in the following claims.

What is claimed is:

1. A method for reducing the visibility of a plume of generally hot, moist process air that is produced by an industrial process and that is exhausted into an environment of ambient, atmospheric air, the method comprising:
exhausting the process air through an outlet into the ambient, atmospheric air; and
providing a flow of auxiliary air at the outlet that surrounds and flows with the process air so as to form a boundary layer between the process air and the ambient, atmospheric air;
wherein the auxiliary air is drier than the process air and warmer than the ambient, atmospheric air; and
wherein the auxiliary air is provided to the process air at a location that is generally adjacent to an output area of the outlet.

2. The method of claim 1, wherein the auxiliary air is provided in the form of a jet of external air that surrounds and travels with the process air at a speed that is greater than or equal to the speed at which the process air is exhausted from the outlet.

3. The method of claim 2, further comprising creative a relative vacuum to exist at the outlet.

4. The method of claim 1, further comprising heating a supply of air to create the auxiliary air.

5. The method of claim 1, further comprising dehumidifying a supply of air to create the auxiliary air.

6. The method of claim 1, wherein the auxiliary air is caused to swirl, to achieve generally uniform circumferential distribution, before being provided to the process air.

7. The method of claim 6, further comprising straightening the auxiliary air before providing it to the process air.

8. An apparatus for exhausting a stream or plume of generally hot, moist process air produced by an industrial process into an environment of ambient, atmospheric air with reduced visibility of the plume of process air, the apparatus comprising:
an outlet having an output area through which the process air is exhausted into the ambient, atmospheric air; and
a combiner element that is configured and disposed to provide a flow of auxiliary air to the process air so that the auxiliary air surrounds and flows with the process air and forms a boundary layer between the process air and the ambient, atmospheric air;
wherein the combiner element is located so as to provide the auxiliary air to the process air at a location that is generally adjacent to the output area of the outlet.

9. The apparatus of claim 8, wherein the combiner element is configured to provide the auxiliary air in the form of a jet of external air that surrounds and travels with the process air at a speed that is greater than or equal to the speed at which the process air is exhausted from the outlet.

10. The apparatus of claim 9, wherein the combiner element comprises a cyclone intake unit.

11. The apparatus of claim 10, further comprising at least one flow straightener.

12. The apparatus of claim 11, further comprising a high-speed ejection section in the output area of the outlet, which creates a relative vacuum in the outlet.
